(19) United States
(12) Patent Application Publication
(10) Pub. No.: US 2005/0239553 A1
(43) Pub. Date: Oct. 27, 2005

(54) Chess notation device

(76) Inventors: F. Leon Wilson, Columbus, OH (US); Mollie S. Givan, Natick, MA (US)

Correspondence Address: Porter, Wright, Morris & Arthur LLP;ATTN: Intellectual Property Department, 28th Floor, 41 South High Street, Columbus, OH, 43215-6194, US

(21) Appl. No.: 11/065,643

(22) Filed: Feb. 24, 2005

Related U.S. Application Data
(60) Provisional application No. 60/547,260, filed on Feb. 24, 2004.

(51) Int. Cl. A63F 13/00

(52) U.S. Cl. 463/46

(57) ABSTRACT

An electronic handheld device for recording a chess game includes preset keys representing pieces of a chess game, preset keys representing rows of a chess board, preset keys representing columns of a chess board, and preset keys representing special nomenclature used for annotation of selected moves of the game pieces. A timer measures time between moves of the game pieces manually entered into the preset keys. Information entered into the preset keys describes moves of game pieces on a chess board during a chess game. Memory is operatively connected to the preset keys and stores the information describing moves of game pieces in chess notation. The device is adapted to electronically record the moves of the game pieces in chess notation but cannot analyze moves of game pieces and cannot compute desired moves of game pieces.

### CROSS-REFERENCE TO RELATED APPLICATIONS

This non-provisional patent application claims priority benefit of U.S. provisional patent application No. 60/547,260 filed on Feb. 24, 2004, the disclosure of which is expressly incorporated herein in its entirety by reference.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to a device to record chess games and, more particularly, to an electronic device which records chess games in several chess notation methods or a user defined notation format.

### BACKGROUND OF THE INVENTION

One of the most important factors in the advancement of chess knowledge was the development of an efficient notation system because chess notation provides a means to record chess games and to discuss specific positions on a chess board. Chess notation can be any means of recording a chess game. Algebraic notation is the most common chess notation in use. Algebraic notation assigns the numbers “1” to “8” for the rows of the board starting from the white side and assigns the letters “a” to “h” for the columns of the board starting from left to right on the white side. Each square on the board is identified by the letter for its column and the number for its row. The chess pieces are identified by a single letter: “P” for pawn; “N” for knight; “R” for rook; “B: for bishop”; “Q” for queen; and “K” for king. A move is recorded by a combination of the identifier for the moving piece plus the square to which it is moving. The move “Qe4”, for example means that a queen was moved to the square e4. Some special moves require special notation such as, for example, castling, pawn promotion, ambiguous moves, capture and check. While Algebraic notation is the common chess notation method used, there are other standard chess notation methods.

During tournament play, only participants are permitted to be present at the game. Coaches cannot see first hand how their students are performing. Therefore, it is difficult to get quality chess instruction unless the participants can accurately record their games with chess notation. Chess coaches and instructors use the notation to review, analyze, and comment on past games in order to improve the player's knowledge of the game. Recording the game, however, can be time consuming and distracting to the game for some players. Additionally, some players do not write legibly. As a result, it is sometimes difficult or impossible to reconstruct a game even when the participant attempted to record the game using chess notation. The situation cannot be corrected by chess computers, personal computers (PC) like laptops, personal digital assistants (PDA), or other such computing devices because no analytical or computing device of any kind can be present during a tournament chess match. Accordingly, there is a need in the art for an improved method and device for easily, accurately, and legibly recording chess games.

### SUMMARY OF THE INVENTION

The present invention provides a method and device which overcomes many of the above-noted problems of the related science and art of chess play. According to the present invention, an electronic handheld device for recording a chess game includes at least one manual input preset for manually entering information describing moves of game pieces on a chess board during a chess game and memory operatively connected to the at least one manual input and storing the information describing moves of game pieces on a chess board during a chess game. A display is operatively connected to the at least one manual input and the memory and displaying at least a portion of the information describing the moves of the game pieces on a chess board during a chess game. The device is adapted to electronically record the moves of the game pieces but cannot analyze moves of game pieces and cannot compute desired moves of game pieces. It should be apparent that the device is a dramatic breakthrough which solves the biggest problems in modern chess—the inability to accurately and legibly record a chess game. This device enables players of all ages to easily, accurately, and legibly record games, especially during tournaments, and thereby helps players to improve their chess playing abilities.

According to another aspect of the present invention, an electronic handheld device for recording a chess game includes a first plurality of preset keys representing pieces of a chess game, a second plurality of preset keys representing rows of a chess board, and a third plurality of preset keys representing columns of a chess board. Information entered into the first, second and third pluralities of preset keys describes moves of game pieces on a chess board during a chess game. Memory is operatively connected to the first, second and third plurality of preset keys and stores the information describing moves of game pieces on a chess board during a chess game.

According to yet another aspect of the present invention, an electronic handheld device for recording a chess game includes a first plurality of preset keys representing pieces of a chess game, a second plurality of preset keys representing rows of a chess board, a third plurality of preset keys representing columns of a chess board, and a fourth plurality of preset keys representing special nomenclature used for annotation of selected moves of the game pieces. A timer measures time between moves of the game pieces manually entered into the preset keys. Information entered into the first, second, third, and fourth pluralities of preset keys describes moves of game pieces on a chess board during a chess game. A display displays at least a portion of the information describing the moves of the game pieces on a chess board during a chess game. Memory is operatively connected to the first, second, third, and fourth plurality of preset keys and stores the information describing moves of game pieces on a chess board during a chess game. The device is adapted to electronically record the moves of the game pieces but cannot analyze moves of game pieces and cannot compute desired moves of game pieces.

From the foregoing disclosure and the following more detailed description of various preferred embodiments it will be apparent to those skilled in the art that the present invention provides a significant advance in the technology and art of chess notation recording methods devices. Particularly significant in this regard is the potential the invention affords for providing a high quality, reliable, and easy to use electronic device. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a front elevational view of a front view of a handheld, electronic device for recording chess games in chess notation according to the present invention;

FIG. 2 is a back elevational view of the electronic device of FIG. 1;

FIG. 3 is a bottom plan view of the electronic device of FIGS. 1 to 3;

FIG. 4 is a diagrammatic view of the device of FIGS. 1 to 3;

FIG. 5 is chart showing how alphanumeric information can be entered into the device of FIGS. 1 to 4;

FIG. 6 is a chart showing international commentary symbols which can be entered into the device of FIGS. 1 to 4;

FIG. 7 is a schematic diagram showing the device of FIGS. 1 to 4 connected to a base unit; and

FIG. 8 is a schematic diagram showing the device of FIGS. 1 to 4 wirelessly connected to a parings tower or tournament manager.

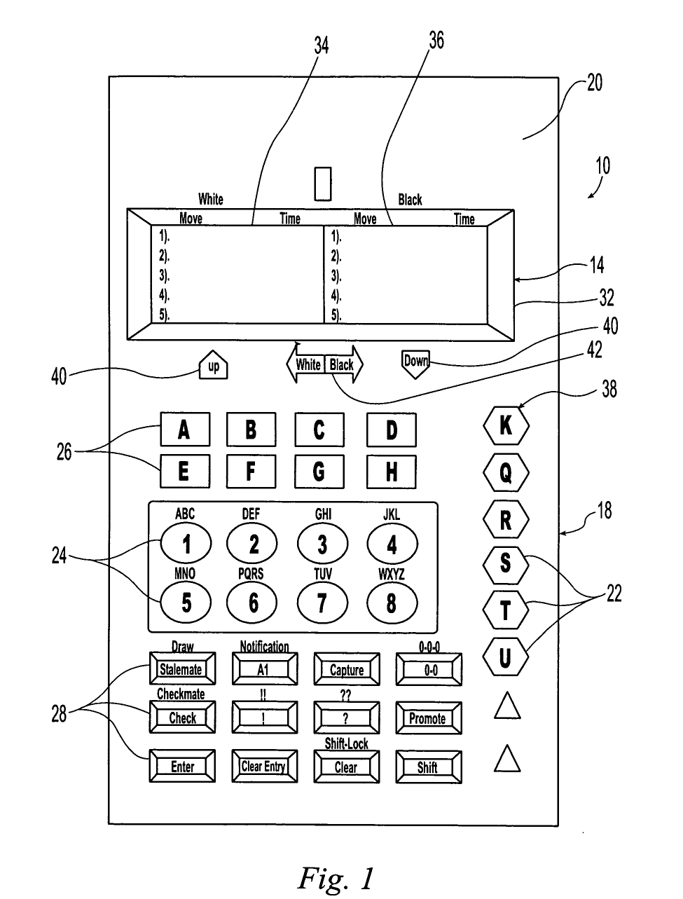

It should be understood that the appended drawings are not necessarily to scale, presenting a somewhat simplified representation of various preferred features illustrative of the basic principles of the invention. The specific design features of a chess notation device as disclosed herein, including, for example, specific dimensions, orientations, locations, and shapes will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the chess notation device illustrated in the drawings. In general, up or upward refers to an upward direction within the plane of the paper in FIG. 1 and down or downward refers to a downward direction within the plane of the paper in FIG. 1. Also in general, fore or forward refers to a direction out of the plane of the paper in FIG. 1 and aft or rearward refers to a direction into the plane of the paper in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved chess notation methods and devices disclosed herein. The following detailed discussion of various alternative and preferred embodiments will illustrate the general principles of the invention with reference to a specific handheld, electronic device. Other embodiments suitable for other applications will be apparent to those skilled in the science and art given the benefit of this disclosure.

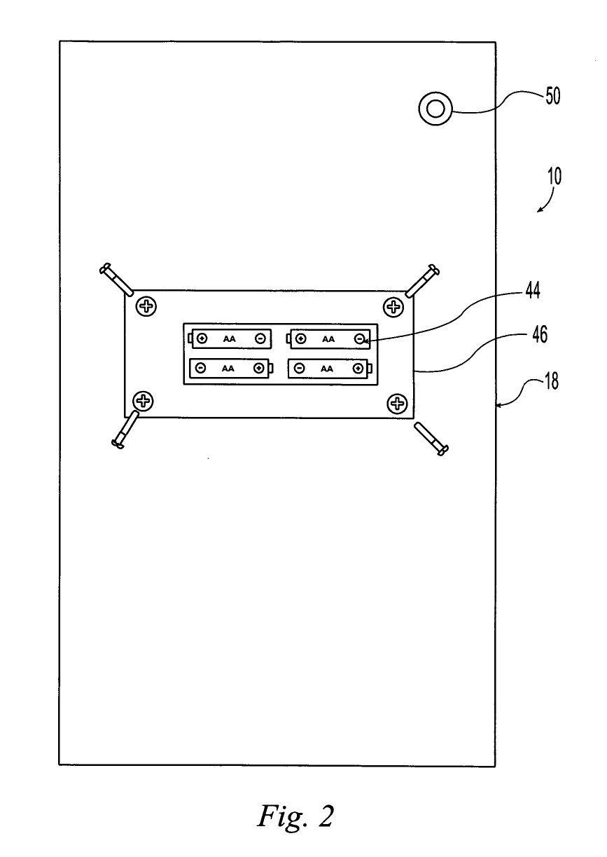

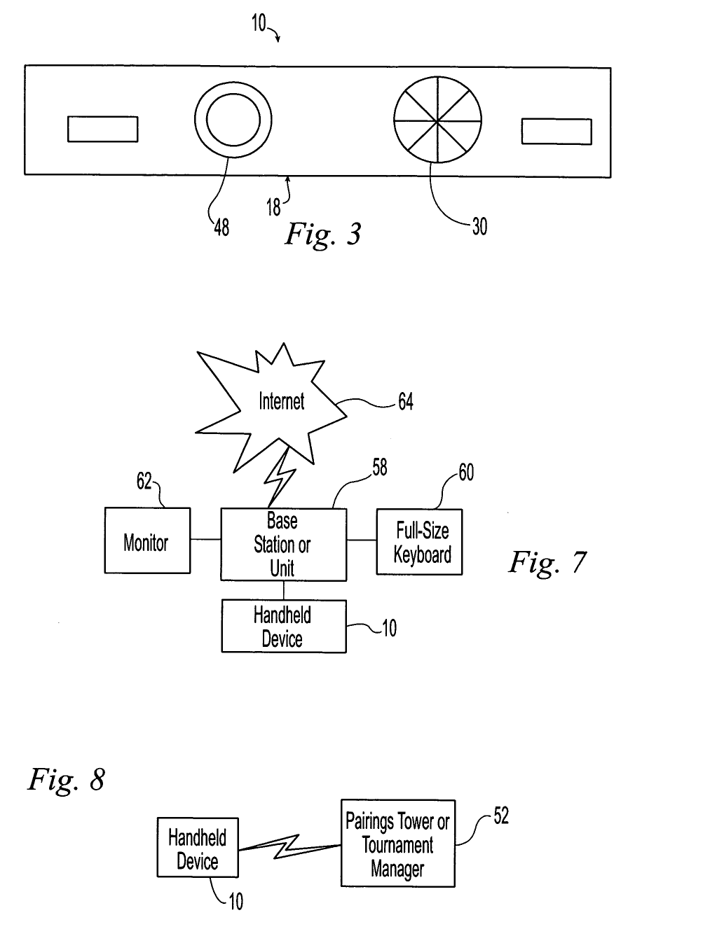

FIGS. 1 to 3 illustrate an electronic, handheld device 10 for recording chess games in chess notation according to the present invention. The term “chess notation” is used in this specification and the appended claims to mean any means devised to record individual moves of a chest game for later viewing. The illustrated device 10 is a “dumb,” that is a non-analytical electronic device that cannot analyze or compute individual chess moves or play a chess game, so that it can be used in tournament play to record games in chess notation. The illustrated device includes input means 12 for inputting information such as individual moves of a chess game, display means 14 for displaying at least one individual move of a chess game, and memory means 16 for storing the individual moves of at least one chess game for later recall. The illustrated device 10 includes a rectangular-shaped and relatively thin housing 18 having a generally planar front face 20. The illustrated housing 18 is sized and shaped so that a user can hold the device 10 in one hand.

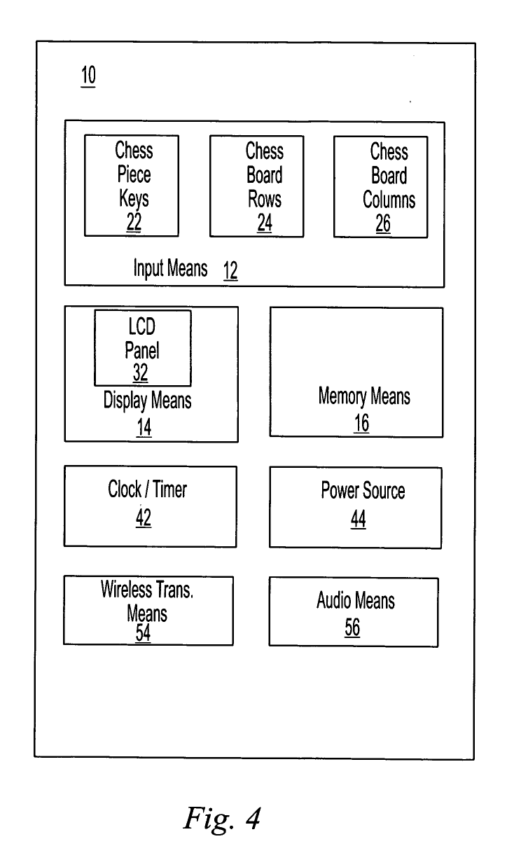

The illustrated input means 12 includes a plurality of predefined or preset keys located on the front face 20 of the device housing 18. The illustrated predefined keys include a first plurality of preset keys 22 representing pieces or units of a chess game. The illustrated first plurality of reset keys 22 includes the following eight keys: a “K” key for the king; a “Q” key for the queen; an “R” key for the rooks; a “B” key for the bishops; an “N” key for the knights; and a “P” key for the pawns. The illustrated predefined keys also include a second plurality of preset keys 24 representing rows of a chess board. The illustrated second plurality of preset keys 24 includes the following eight keys: a “1” key for the first row of the chest board; a “2” key for the second row of the chest board; a “3” key for the third row of the chest board; a “4” key for the fourth row of the chest board; a “5” key for the fifth row of the chest board; a “6” key for the sixth row of the chest board; a “7” for the seventh row of the chest board; and an “8” key for the eighth column of the chest board. The illustrated second plurality of keys also be used to enter text information by using Shift and Shift-Lock keys. FIG. 4 illustrates a key guide showing how the illustrated second plurality of keys 24 can be used for entering alphanumeric information. The illustrated predefined keys also include a third plurality of preset keys 26 representing columns of a chess board. The illustrated second plurality of preset keys includes the following eight keys: an “A” key for the first column of the chest board; a “B” key for the second column of the chest board; a “C” key for the third column of the chest board; a “D” key for the fourth column of the chest board; an “E” key for the fifth column of the chest board; an “F” key for the sixth column of the chest board; a “G” key for the seventh column of the chest board; and an “H” key for the eighth column of the chest board.

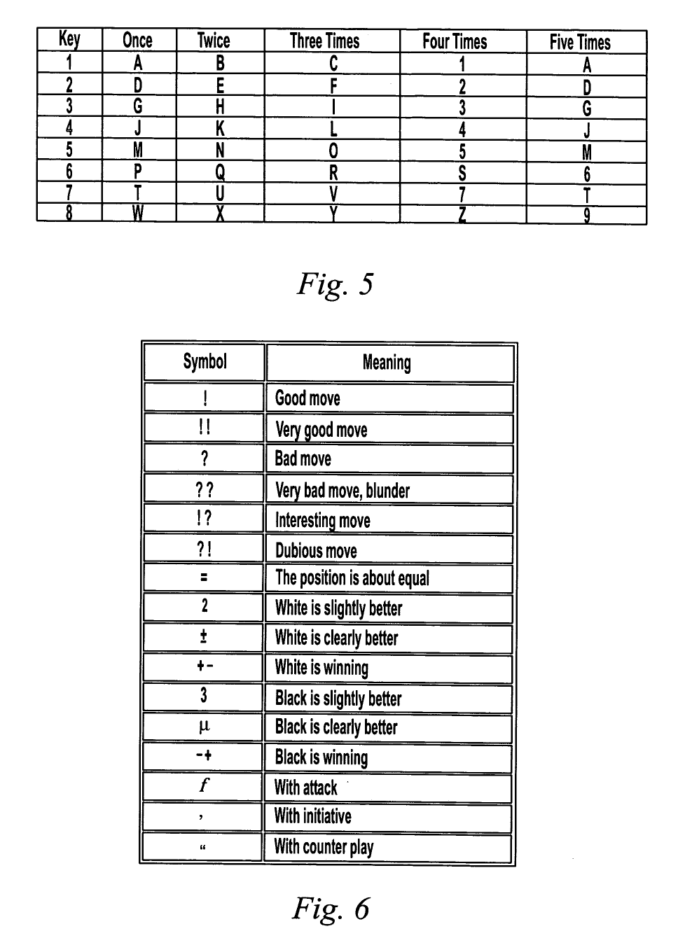

The illustrated keys also include a fourth plurality of preset keys 28 representing special nomenclature used for annotation of selected moves of the chess pieces, standard international commentary symbols, and operational functions of the device 10. The illustrated special nomenclature keys include a “Stalemate” key which is also a “Draw” key when shifted, a “Check” key which is also a “Checkmate” key when shifted, an “At” key which is also a “notation key when shifted, a “Capture” key, a “0-0” key which is also a “0-0-0” key when shifted, and a “Promote” key. The illustrated commentary keys include an “!” key which is also an “!!” key when shifted, an “?” key which is also a “??” key when shifted. FIG. 5 illustrates the most common system of commentary symbols used to annotate moves or positions that can be read in any language and immediately understood by chess players all over the world. The illustrated operational keys include an “ENTER” key, “clear Entry” key, a “Clear” key which is also a “Shift-Lock” key when shifted, and a “Shift” key. While the illustrated preset keys 22, 24, 26, 28 are adapted for easy input of algebraic notation, it is noted that the preset keys 22, 24, 26, 28 can alternatively be adapted for easy input of any other notation system, symbols or the like.

The illustrated device 10 is provided with a connector 30 that can be used to connect a keyboard if desired to ease input of text information when desired. It also is noted that each of the plurality of predefined keys 22, 24, 26, 28 can alternatively include any other quantities or types of keys and there can alternatively be any other quantity of types of pluralities of keys. It is further noted that the input means 12 can take any other suitable form such as, for example, a keyboard, a touch screen display, a toggle, mouse, trackball, voice activation, and the like or any combination thereof.

The illustrated display means 14 includes a liquid crystal display (LCD) screen or panel 32. The LCD screen 32 preferably is backlit and the user can select the backlight to be on or off. FIG. shows the LCD screen 32 in the move display mode where the display includes a first or “White” column 34 and a second or “Black” column 36 and each column 34, 36 can display five rows of moves and related times when the LCD display is in standard display mode. The LCD screen 32 preferably has an enhanced display mode in which ten moves are displayed. The illustrated device 10 includes column controls 38 in the form of first and second or “White” and “Black” keys to select a column, that is, move a cursor between the columns 34, 36. The illustrated device 10 also includes scroll controls 40 so that the user can scroll through the recorded moves. It also is noted that the LCD screen 32 can alternatively display any other quantity of moves and can alternatively have any other suitable format. It is further noted that the display means 14 can take any other suitable form.

The memory means or memory device 16 can take any suitable form for electronically storing at least one chess game. It is noted that the memory device 16 is sized to store at least one chess game but is preferably is sized to electronically store a plurality of chess games. Chess games are saved in the memory 16 preferably in NMP or as text so that they are editable by a standard text editor.

The device 10 preferably has an internal double clock or timer 42 to record times taken by both players. The move timer records how long it takes to make and record a move. The chess clock records the time between entering the users moves and has no further statistical relevance. This timing information is later helpful during game analysis to determine where the user spent the most time.

The device 10 is preferably powered by a DC source of power 44 such as batteries. The illustrated device is powered by four commercially available AA batteries 44 located within a battery compartment in the housing 10 and accessed through a removable panel 46 located on a rear face of the device 10. The illustrated device 10 is also provided with a power connector 48 so that an AC adapter can be utilized to connect the device 10 to a standard AC source of power. It is noted that the device 10 can alternatively be powered by any other type or quantity of batteries and the device 10 can alternatively be powered by any other suitable source of power 44.

The device 10 is preferably provided with an on/off switch 50 to selectively power and turn off the device 10. The illustrated on/off switch 50 is located on the rear side of the device 10 to reduce the likelihood of accidentally turning the device 10 off during a chess game. It is noted that the on/off switch 50 can alternative be provided at any other suitable location. The device 10 can alternatively be powered by engaging an on-switch and unpowered or turned off by a series of key strokes such as, for example, simultaneously holding down both the ENTER and Check keys and then pressing the King key three times.

The user's personal profile can preferably be entered and recalled without reentering the information. To access the user's personal player profile, the user preferably presses and holds the on/off switch 50 while also pressing and holding the ENTER key. The password prompt appears in the display screen 32. The user then follows the prompts to enter and store a personal password and the user's United Sates Chess Federation (USCF) and FIDE membership numbers, current rating, event, date and location. In addition, the user can enter up to ten other player's profiles so that the user can quickly set tournament information.

When the device 10 is first turned on, the display screen 32 is reset to the first or white column with a move counter set at 000 and a move timer set to 00:00:00. If the user previously entered their name and USCF or FIDE membership number as owner of the device, than the device 10 preferably prompts the user to select whether the user is playing light (white) or dark (black). If desired, paring information can be entered using the second plurality of preset keys 24 or a keyboard attached to the device 10. The paring information preferably includes the event name, date, opponent, location, section, round number, board number, time control, opponent's rating, and your rating. If the user is playing in an appropriately enabled tournament, the user simply points the device 10 at the parings tower 52 and the paring information will be wirelessly and automatically input into the device 10 (best shown in FIG. 7). It is noted that the wireless transmission means 54 of the device 10 preferably incorporate advanced security, authentication, and encryption technologies. Once the chess game is complete, notation data can be wirelessly sent to the parings tower or tournament manager 52.

To start notating a new chess game the user selects NEW game. If the user has already started notating a chess game, the user is prompted to SAVE the current game. The user selects YES to save the current game in memory and start a new game or NO to discard the current game from memory and start a new game. Preferably, the memory means 16 of the device 10 is capable of storing more than one chess game but alternatively the device can be adapted to save only one chess game if desired. The user is prompted to enter non-tournament or tournament mode. Once in tournament mode, the user cannot access saved chess games. The device 10 is then ready to accurately and legibly record a chess game. The default notation format is algebraic notation, however, the user can select and set the notation format if another notation format is desired. Preferably, the change notation mode is not available while in tournament mode. The device 10 preferably provides the user with the flexibility to change notation systems at any point during a non-tournament chess game. To change notation systems, the user simultaneously presses the Shift and Notation keys. Each press of the keys changes the current notation format. Preferably the device 10 supports the following notation formats: (1) Algebraic Notation’ (2) Long Algebraic Notation; (3) Descriptive Notation; (4) Figurine Notation; (5) Forsythe Notation; (6) Udemann Code; (7) International Notation; and (8) User-defied (custom) mode.

To start the internal timer 42, an Edit/Pause/Play switch, which is selectively displayed on the display screen 32, is moved to the play position. The user than, enters each move for each of the players into the device 10. To enter a move, the user selects the key representing the piece to be moved and then keys representing the new location of the moved piece (column and row). As a move is entered, the move is displayed on the screen. If two of the same type of pieces can be moved to the new location of the piece, so that the above described input would be ambiguous, the user selects the key representing the piece to be moved, presses the At key, presses the keys representing the current location of the piece to be moved (column and row), and then presses keys representing the new location of the moved piece (column and row). Castling is entered by pressing the 0-0 key for a Kingside or short side castling and pressing the 0-0-0 key for a Queenside or long side castling. If the user desires, the Capture key can be pressed when a move captures an opponent's piece. Typically the capture key is used by young and/or inexperienced players. The Check key is pressed if a moves places the opponent in check. Pawn promotion is entered by pressing the Promote key and then selecting the piece you want to promote to. The device 10 preferably will not allow a pawn to be promoted to a king or pawn. The device 10 preferably will allow the user to enter illegal moves when in the tournament mode but not in the non-tournament mode. The device 10 preferably has an auto save feature which the user can select to automatically save all moves to the internal memory 16. The device concludes recording the chess game, for example, when the Checkmate, Stalemate or Draw keys are pressed indicating the end of the chess game.

The device 10 is preferably provided with audio means 56 to announce spoken audio of all moves made when in a play back mode. The audio means 56 can include a speaker, a connector for connecting head or earphones, or the like. The device 10 preferably allows the user to select whether the spoken moves announcement is on or off.

The device 10 automatically records the time of the move based on the internal timer 42 which was started when the Edit/Pause/Play switch was moved to the play position. If the user needs to stop at any time during a game, the user slides the Edit/Pause/Play switch to the pause position and the internal timer 42 is stopped until the switch is returned to the play position. If at any time the user wants to change or edit any of the already entered moves, the user moves the Edit/Pause/Play switch to the edit position. The user then presses the SHIFT key while pressing the up arrow key until the move that needs to be changed or edited appears. Preferably, an asterisk or other mark is placed by any move that is changed after it is initially entered. Preferably, the asterisks or other marks can be removed when beaming or uploading a stored chess game by selecting an absolute mode.

A stand can be provided for the handheld device 10 which supports the device 10 on a tabletop at an angle to make it comfortable to see the keys 22, 24, 26, 28 when entering notation information during a match. The stand is preferably adjustable so that individual users can custom fit their entry position. The stand preferably has a base having enough weight so that the stand is unlikely to be accidentally knocked over. Preferably felt pads or the like are provided on the bottom of the stand to prevent slipping or possible damage to the tabletop.

As best shown in FIG. 6, the handheld device 10 is connectable to a base or docking unit 58. The handheld device 10 can be connected to the base unit 58 in any suitable manner such as, for example, a wireless connection, a cable connection, a direct connector connection, or the like. The base unit 58 is preferably specifically designed for use with the handheld device 10. When the handheld device 10 is connected to the base unit 58, the base unit 58 expands the capabilities of the handheld device 10. The base unit 58 receives the notation information or data which was entered and stored in the “dumb” handheld device 10. The base unit 58 enables replay of chess games for reviewing and/or critique. The base unit 58 also enables a larger number of chess games to be stored in memory such as, for example, about 2500 games and keeps track of statistics for individual players. The base unit 58 can preferably pause auto playback, speed-up auto playback, and modify moves for further analysis. The base unit 58 can also have the ability to play new chess games, although the record of these new chess games are not entered into the statistics.

The base unit 58 preferably has slots for expansion cards, bays for storage devices, and connectors for peripheral devices such as, for example, computers, printers, monitors, keyboards, mice, and the like. Once the handheld device 10 is connected to the base unit 58, it essentially becomes a full functioning chess computer capable with interfacing with many of the popular chess programs and databases. When the handheld device 10 is disconnected from the base unit 58, the handheld device 10 becomes a portable chess notation recorder. Notation stored in the handheld device 10 is accessible when both docked and undocked to the base unit 58 because the notation resides in the base unit 58. The base unit 58 enables the user to simultaneously enjoy expansion possibilities of a chess computer with the portability of the portable handheld device 10. In addition, the base unit 58 enables the user to use a full-size keyboard 60, monitor 62, and wireless internet connection 64. It is noted that the base unit 58 can alternatively be a standard personal computer or the like having software compatible with the handheld device 10.

Form the foregoing disclosure and detailed description, it is apparent that the portable handheld device enables each move during a chess game to be easily recorded to the internal memory 16 in several standard chess notation formats or a user-defined (custom) notation format by simply pressing a series of keys 22, 24, 26, 28 on the device 10. The device 10 has a variety of preset keys 22, 24, 26, 28 that cover each and every situation encountered during the chess game. The display screen 32 shows the most recent moves by the players. After the chess game, the entire chess game can be reviewed on the display or the information can be transferred to another device such as the base unit 58 for display, analysis, storage, and the like. Thus, the portable, handheld device 10 of the present invention solves the two of the biggest problems in modern chess, accuracy and legibility of recorded chess games.

From the foregoing disclosure and detailed description of certain preferred embodiments, it is also be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. An electronic handheld device for recording a chess game, said device comprising:
at least one manual input preset for manually entering information describing moves of game pieces on a chess board during a chess game;
memory operatively connected to the at least one manual input and storing the information describing moves of game pieces on a chess board during a chess game; and
a display operatively connected to the at least one manual input and the memory and displaying at least a portion of the information describing the moves of the game pieces on a chess board during a chess game; and
wherein the device is adapted to electronically record the moves of the game pieces but cannot analyze moves of game pieces and cannot compute desired moves of game pieces.

2. The electronic handheld device according to claim 1, wherein the at least one input includes a first plurality of preset keys representing the game pieces.

3. The electronic handheld device according to claim 2, wherein the at least one input includes a second plurality of preset keys representing rows of a chess board.

4. The electronic handheld device according to claim 3, wherein the at least one input includes a second plurality of preset keys representing columns of a chess board.

5. The electronic handheld device according to claim 4, wherein the at least one input includes a fourth plurality of preset keys representing special nomenclature used for annotation of selected moves of the game pieces.

6. The electronic handheld device according to claim 1, wherein the at least one input includes a plurality of preset keys representing special nomenclature used for annotation of selected moves of the game pieces.

7. The electronic handheld device according to claim 1, wherein the display includes an LCD panel.

8. The electronic handheld device according to claim 1, further comprising a timer measuring time between moves of the game pieces manually entered into the input.

9. The electronic handheld device according to claim 1, further comprising wireless transmission means for transmitting the electronically recorded moves of the game pieces.

10. The electronic handheld device according to claim 1, further comprising audio means selectively announcing spoken audio of the recorded moves of the game pieces.

11. An electronic handheld device for recording a chess game, said device comprising:
a first plurality of preset keys representing pieces of a chess game;
a second plurality of preset keys representing rows of a chess board;
a third plurality of preset keys representing columns of a chess board;
wherein information entered into the first, second and third pluralities of preset keys describes moves of game pieces on a chess board during a chess game; and
memory operatively connected to the first, second and third plurality of preset keys and storing the information describing moves of game pieces on a chess board during a chess game.

12. The chess notation device according to claim 11, further comprising a fourth plurality of preset keys representing special nomenclature used for annotation of selected moves of the game pieces.

13. The electronic handheld device according to claim 11, wherein the display includes an LCD panel.

14. The electronic handheld device according to claim 11, further comprising a timer measuring time between moves of the game pieces manually entered into the preset keys.

15. The electronic handheld device according to claim 11, further comprising wireless transmission means for transmitting the electronically recorded moves of the game pieces.

16. The electronic handheld device according to claim 11, further comprising audio means selectively announcing spoken audio of the recorded moves of the game pieces.

17. The electronic handheld device according to claim 11, further comprising a display displaying at least a portion of the information describing the moves of the game pieces on a chess board during a chess game.

18. The electronic handheld device according to claim 11, wherein the device is adapted to electronically record the moves of the game pieces but cannot analyze moves of game pieces and cannot compute desired moves of game pieces.

19. An electronic handheld device for recording a chess game, said device comprising:
a first plurality of preset keys representing pieces of a chess game;
a second plurality of preset keys representing rows of a chess board;
a third plurality of preset keys representing columns of a chess board;
a fourth plurality of preset keys representing special nomenclature used for annotation of selected moves of the game pieces;
a timer measuring time between moves of the game pieces manually entered into the preset keys;
wherein information entered into the first, second, third, and fourth pluralities of preset keys describes moves of game pieces on a chess board during a chess game;
a display displaying at least a portion of the information describing the moves of the game pieces on a chess board during a chess game;
memory operatively connected to the first, second, third and fourth plurality of preset keys and storing the information describing moves of game pieces on a chess board during a chess game; and
wherein the device is adapted to electronically record the moves of the game pieces but cannot analyze moves of game pieces and cannot compute desired moves of game pieces.

20. The electronic handheld device according to claim 19, further comprising wireless transmission means for transmitting the electronically recorded moves of the game pieces.
